(19) United States
(12) Patent Application Publication
(10) Pub. No.: US 2006/0016548 A1
(43) Pub. Date: Jan. 26, 2006

(54) Manufacturing method of window blinds with patterns

(76) Inventors: Chong Boon Chang, Selangor (MY); Richard Ginelli, Oakland, NJ (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(21) Appl. No.: 10/951,518

(22) Filed: Sep. 28, 2004

(30) Foreign Application Priority Data
Jul. 26, 2004 (CN) 200410070770.X

(51) Int. Cl. B44C 1/165; B41F 17/00; B32B 31/00

(52) U.S. Cl. 156/230; 101/35; 101/41; 101/36; 156/238; 156/250

(57) ABSTRACT

A manufacturing method for window blinds with patterns, comprises the following procedures: Manufacturing transfer film with patterns; Usage of a transfer printing machine that combines said transfer film and window blind vane base materials and then heat them to 100˜200° C. under pressure 5˜8 kg/cm²; Separate said transfer film and window blinds vane with patterns on said transfer film transferred onto said vanes base materials to obtain window blinds vane with patterns. Compared with the existing technology, the present invention has the following technical effects: patterns are transferred to window blinds vane by transfer to obtain various colorful patterns with fresh colors and good visual effects; Colors will not fade for a long period of time in use and the vane is easy to clean; High productivity.

### FIELD OF INVENTION

This invention is directed to window blinds, especially a method of transferring patterns onto the vane by printing.

### BACKGROUND OF THE INVENTION

There are basically two existing methods of manufacturing window blinds vane with patterns: one being the Chinese patent CN93103122.2 A Method of Manufacturing Window Blinds Vane with Patterns, in which the stripe-shaped vanes are rolled through a pair of rollers before being cooled and given shape, the rollers having patterns on their surfaces, and window blinds vanes with patterns can be obtained after cooling. But the patterns made in this way are monotony with inferior visual effect. The U.S. Pat. No. 5,263,529 provides another manufacturing method for the window blinds vane with patterns, in which decoration patches are adhered to each of the vanes and all the vanes form a complete pattern. Disadvantage of this method is that the decoration patches are easy to fall off and the method is complicated and the vane is not easy to clean.

### BRIEF SUMMERY OF THE INVENTION

The present invention is aimed to avoid disadvantages mentioned above and to provide a manufacturing method for window blinds vane with patterns. The vanes manufactured by this method have good visual effects and long service life.

The technical problems can be solved by the current invention through the following technical plan:

Put forward a manufacturing method for window blinds with patterns, which comprises the following procedures:
\textcircled{1} Manufacturing transfer films with patterns;
\textcircled{2} Use a transfer printing machine to heat and press the combined transfer films and window blinds vane base material to a temperature 100˜200° C. under a pressure 5˜8 kg/cm²;
\textcircled{3} Separate said transfer films and window blinds vane base material and the patterns are already transferred to the base material to form vane with patterns.

Compared with the existing technology, the present invention has the following technical effects:
1. In the present invention, patterns are transferred to window blinds vane by transfer to obtain various colorful patterns with fresh colors and good visual effects;
2. Colors will not fade for a long period of time in use and the vane is easy to clean;
3. High productivity.

### BRIEF DESCRIPTION OF THE DRAWINGS

FIG. 1 is a sketch of the current invention of the manufacturing method for window blinds vane with patterns by way of transfer printing machine;

FIG. 2 is a sketch of the current invention of the manufacturing method for window blinds vane with patterns by way of a hot stamping machine.

### PREFERRED EMBODIMENT

The present invention shall be further described in combination with the attached figures of the preferred embodiment.

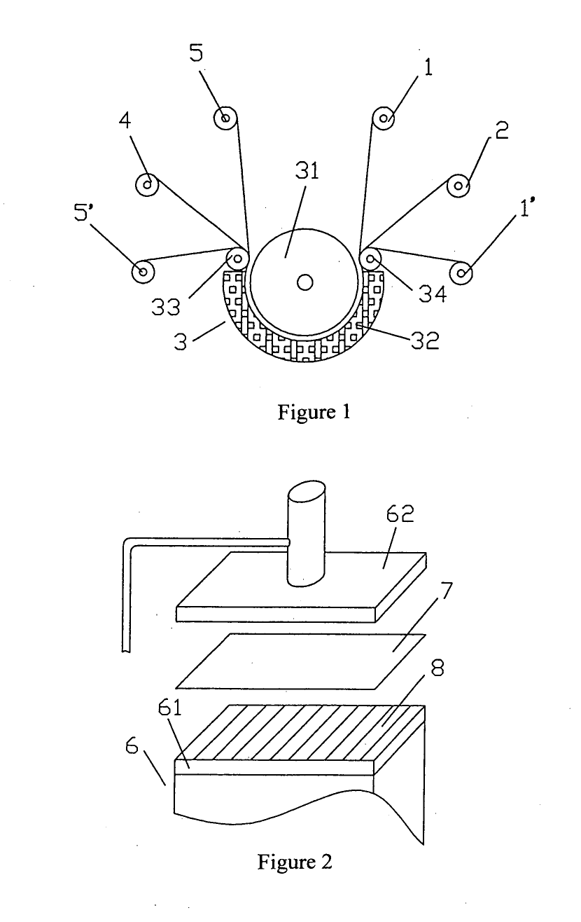

In the first preferred embodiment of the present invention, a transfer printing machine is used and said transfer films and window blinds vane base materials are rolls as shown in FIG. 1. Details follow:

Install two transfer films 1 and 1′ and one wind blinds vane base material 2 onto the winding-up and feeding devices of the transfer printing machine 3; said two transfer films 1 and 1′ and window blinds vane base material 2 are fed from the roller 34 on the right side into the gap between the outer surface of the heating roller 31 of the transfer printing machine and the inner surface of heat-resistant felt 32, both sides of said window blinds vane base material 2 are combined with the transfer films 1 and 1′, respectively, which then are exposed to temperature 100˜200° C. under a pressure of 5˜8 kg between the outer surface of the heating roller 31 of the transfer printing machine 3 and the inner surface of the heat-resistant felt 32; said combined transfer films and window blinds vane base material go around the outer surface of the heating roller 31 of the transfer printing machine 3 and the inner surface of the heat-resistant felt 32 for more than half a circle to the roller 33 on the left side. Said transfer films 1 and 1′ will separate from vane 2 and the patterns on said transfer films 1 and 1′ are transferred to the vane 2 to obtain window blinds vane 4 with patterns; at the same time, the winding-up and feed rolls of said transfer printing machine take up said vane 4 and waste films 5 and 5′ that have already their patterns transferred; as the last procedure, said window blinds vane with patterns will be cut to the given length.

The base material of said window blinds vane in the present invention can be aluminum or PVC sheets. When aluminum is used, the optimum heating temperature of the heating rollers shall be 180° C. and the optimum pressure of such heating rollers shall be 6 kg/cm², and when PVC is used, such parameters shall be 120° C. and 6 kg/cm², respectively. This preferred embodiment is applicable to dual-sided printed patterns, which usually are continuous.

In the second preferred embodiment of the present invention, a hot stamping machine is used and said transfer films are single sheets as shown in FIG. 2. Details follow:

First of all, said window blinds vane base material is cut to the given length and all the vane base materials 8 for a window blind shall be arranged on the base plate 61 of said hot stamping machine 6 and fixed by fixtures(not shown in the figure) on the base plate 61 correspondingly; then the already prepared transfer film 7 with patterns is put onto said base plate 61 and fixed; the heating plate 62 of said hot stamping machine 6 will be lowered to make said transfer film 7 and all the window blinds vane base materials 8 combined, and said heating plate 62 will be controlled at a temperature 100˜200° C. with pressure pneumatically controlled at 5˜8 kg/cm²; said heating plate 62 then is lifted and said transfer film 7 will separate from all the window blinds vanes 8, patterns on said transfer film 7 are already transferred onto said vane base materials 8 to obtain window blinds vanes with patterns.

The base material of said window blinds vanes in the present invention can be of aluminum or PVC sheets. When aluminum is used, the optimum heating temperature of the heating rollers shall be 180° C. and the optimum pressure of such heating rollers shall be 6 kg/cm², and when PVC is used, such parameters shall be 120° C. and 6 kg/cm², respectively. This preferred embodiment is applicable to one-sided printed patterns, which usually are individualized.

What is claimed:

1. A manufacturing method for window blinds with patterns is characterized by:
\textcircled{1} Manufacturing transfer film with patterns;
It is also characterized by the following procedures:
\textcircled{2} Usage of a transfer printing machine that combines said transfer film and window blind vane base materials and then heat them to 100˜200° C. under pressure 5˜8 kg/cm²;
\textcircled{3} Separate said transfer film and window blinds vane with patterns on said transfer film transferred onto said vanes base materials to obtain window blinds vane with patterns.

2. A manufacturing method for window blinds with patterns that is defined in claim 1 is characterized by: said transfer film and window blinds vane base materials are in rolls and the final vane with patterns shall be cut to the given length.

3. A manufacturing method for window blinds with patterns that is defined in claim 2 is characterized by: said window blinds vane base materials are first combined with and then separated from the transfer film on both sides to obtain window blinds vane with patterns on both sides.

4. A manufacturing method for window blinds with patterns that is defined in claim 1 is characterized by: said transfer printing machine is a hot stamping machine and said transfer film is single sheet; before combined with said transfer film, said vane base materials are cut to the given length and all the vanes are arranged onto, and fixed by fixtures of, the base plate of said hot stamping machine.

5. A manufacturing method for window blinds with patterns that is defined in claim 1 is characterized by: base material of said vane is aluminum.

6. A manufacturing method for window blinds with patterns that is defined in claim 5 is characterized by: said optimum heating temperature is 180° C. and said optimum pressure 6 kg/cm².

7. A manufacturing method for window blinds with patterns that is defined in claim 1 is characterized by: said window blinds vane is of PVC (polyvinyl chloride) sheet.

8. A manufacturing method for window blinds with patterns that is defined in claim 7 is characterized by: said optimum heating temperature is 120° C. and said optimum pressure 6 kg/cm².
